(19) United States
(12) Patent Application Publication
(10) Pub. No.: US 2003/0067441 A1
(43) Pub. Date: Apr. 10, 2003

(54) Presentation system using laser pointer

(75) Inventors: Akinori Hamana, Saitama (JP); Junichi Yokoyama, Saitama (JP)

Correspondence Address: OLIFF & BERRIDGE, PLC, P.O. BOX 19928, ALEXANDRIA, VA, 22320, US

(73) Assignee: FUJI PHOTO OPTICAL CO., LTD., Saitama (JP)

(21) Appl. No.: 10/254,794

(22) Filed: Sep. 26, 2002

(30) Foreign Application Priority Data
Sep. 28, 2001 (JP) 2001-299245

(51) Int. Cl. G09G 5/00

(52) U.S. Cl. 345/156

(57) ABSTRACT

A presentation system using a laser pointer, comprises: a screen device; a projecting device for projecting a visible image onto the screen device; and a laser pointer operated by a user, and projecting a laser beam onto the screen device. The laser pointer comprises: an infrared light emitting device for emitting an infrared light approximately in the same direction as a projection direction of the laser beam; and a switching device for switching the mode between a laser pointer mode for projecting the laser beam and a mouse mode for emitting the infrared light from the infrared light emitting device. The presentation system further comprises: an infrared light sensing device for sensing a projected image of the infrared light emitted from the infrared light emitting device to the screen device; and a processing section for generating movement data consisting of a movement direction and a movement distance of the projected image of the infrared light sensed by the infrared light sensing device, and for supplying the movement data to the projecting device. The projecting device projects a mouse image onto the screen device based on the movement data supplied from the processing section.

### BACKGROUND OF THE INVENTION

1. Field of the Invention

The present invention relates to a presentation system for making a presentation in a lecture, or the like, while pointing to an image displayed on a screen using a laser pointer. More particularly, the present invention relates to a system which enables mouse operation on the screen of a personal computer using a laser pointer.

2. Description of the Related Art

When making a presentation in a lecture or the like using a liquid crystal projector, a laser pointer which projects a laser beam onto a screen and indicates a point of interest on the screen is often used. In recent years, presentations are often performed while projecting images on a display of a personal computer onto a screen. In these cases, a mouse, which is one of the input devices for the personal computer, is operated.

The mouse is usually operated by the presenter and the mouse is connected to the personal computer. Therefore, it is necessary to dispose the personal computer near the presenter, and the position of the presenter is therefore restricted. When the presenter operates the mouse, the presenter must shift the hand from the laser pointer to the mouse. Thus, it is troublesome to shift the hand from the laser pointer to the mouse, or vice versa, and this is one problem preventing from making a smooth presentation. There may be provided a wireless joystick which the presenter can operate at a remote position away from the personal computer instead of the mouse. According to a method using the wireless joystick, the ON/OFF operation of a switch is converted to pulses, and there is a disadvantage in that there is a lack of operational sensation, and this method is therefore unsatisfactory for presentations.

### SUMMARY OF THE INVENTION

It is, therefore, an object of the present invention to provide a presentation system using a laser pointer, in which shift from a laser pointer to a mouse, or vice versa, can be swiftly performed, thereby allowing a smooth presentation to be given.

The present invention provides a presentation system using a laser pointer, comprising: a screen device; a projecting device for projecting a visible image onto the screen device; and a laser pointer operated by a user, projecting a laser beam onto the screen device. The laser pointer comprising: an infrared light emitting device for emitting an infrared light approximately in the same direction as a projection direction of the laser beam; and a switching device for switching the mode between a laser pointer mode for projecting the laser beam and a mouse mode for emitting the infrared light from the infrared light emitting device. The presentation system further comprises: an infrared light sensing device for sensing a projected image of the infrared light emitted from the infrared light emitting device to the screen device; and a processing section for generating movement data consisting of a movement direction and a movement distance of the projected image of the infrared light sensed by the infrared light sensing device, and for supplying the movement data to the projecting device. The projecting device projects a mouse image onto the screen device based on the movement data supplied from the processing section.

According to the present invention, the switching device provided on the laser pointer can change the mode to the laser pointer mode to project a laser beam or to the mouse mode for a mouse operation. In the laser pointer mode, the laser beam is projected. By directing the laser beam toward the screen device, the laser beam is projected onto the screen device. In the mouse mode, the infrared light is emitted from the infrared light emitting device. If the laser pointer is directed toward the screen device in this state, the infrared light as an invisible image is projected onto the screen device. The movement of the projected image of the infrared light is detected by the infrared light sensing device which is disposed at an appropriate location and movement data about the movement direction and the movement distance of the projected image is supplied to the processing section. The processing section generates a mouse image based on the movement data and supplies the generated mouse image to the projecting device, and the projecting device projects the mouse image onto the screen device. That is, a mouse image according to the movement of the laser pointer is projected from the projecting device onto the screen device in real time.

According to the present invention, unlike in conventional systems, the laser pointer set in the mouse mode is moved intuitively, in contrast to using a mouse or a joystick, whereby a mouse operation can be performed easily. The presenter can swiftly change the mode to the laser pointer mode or to the mouse mode using the switching device of the laser pointer. Therefore, restrictions necessitating that a personal computer be disposed near the presenter to perform the mouse operation and that the presenter not be away from the personal computer and the like do not exist. The freedom of the position and movement of the presenter is thereby improved. It is thus possible to give a smooth presentation.

Moreover, if a mouse image is to be formed, then the infrared light sensing device senses the projected image of infrared light, only the movement direction and movement distance of the projected image are converted, and a mouse image is generated instead of operating the absolute position of the projected image of the infrared light as coordinates of the infrared light and projecting the mouse image onto the screen device from the operation result. Therefore, the program of the processing section is not required to be complicated, making it possible to minimize cost. The mouse operation by the presenter is performed by the presenter adjusting the movement of the mouse image to a desired location while viewing the mouse image projected onto the screen device.

According to the present invention, as an additional constitution, the system further comprises: a human body sensor for sensing heat emitted from a human body present in the projection direction of the laser beam from the laser pointer; and a laser beam control device for controlling the projection of the laser beam projected from the laser pointer when the human body sensor operates.

With this constitution, if a person is present in the projection direction of the laser beam, the presence of the person is sensed by the human body sensor and the projection of the laser beam is restricted by the laser beam control device. The restriction of the projection of the laser beam in this case causes the device to stop projecting the laser beam or to reduce the intensity of the laser beam to a harmless level. This constitution enables avoiding the danger of projecting laser beam onto an eye in the laser pointer mode. The human body sensor may be provided on, for example, the laser pointer, or it may be provided on the screen device, the projecting device, or the like. As the human body sensor, a sensor which detects an infrared ray emitted from a human body may be appropriately employed.

Furthermore, as device for avoiding the risk of the laser beam, the following constitution, in addition to those stated above, may be provided. That is, the presentation system further comprises: an infrared light projecting device for projecting infrared light over approximately the entire surface of the screen device. The laser pointer comprises: an infrared light receiving section for receiving the infrared light oriented in the same direction as the projection direction of the laser beam, projected from the infrared light projecting device and reflected by the screen device; and a laser beam control device for projecting the laser beam only when the infrared light receiving section receives the infrared light.

With this constitution, while the laser pointer is directed toward the screen device, the infrared light receiving section provided on the laser pointer receives the infrared light reflected by the screen device. At this time, laser beam is projected from the laser pointer and the laser beam is projected onto the screen device. If the direction of the laser pointer is away from the screen device, the infrared light receiving section does not receive the infrared light reflected by the screen device and no laser beam is projected. That is, the laser beam is projected only when the laser pointer is directed toward the screen device. This constitution allows the danger of projecting a laser beam onto an eye in the laser pointer mode to be avoided.

### BRIEF DESCRIPTION OF THE DRAWINGS

FIG. 1 is a conceptual view of a system in the first embodiment according to the present invention;

FIG. 2 is a perspective view of a laser pointer in the first embodiment according to the present invention;

FIG. 3 is a block diagram showing the configuration of the laser pointer in the first embodiment according to the present invention;

FIG. 4 is a conceptual view of a system in the second embodiment according to the present invention;

FIG. 5 is a perspective view of a laser pointer in the second embodiment according to the present invention;

FIG. 6 is a block diagram showing the configuration of the laser pointer in the second embodiment according to the present invention; and

FIG. 7 is a conceptual view of ON/OFF states of the laser pointer according to a wavelength range of infrared light in the second embodiment according to the present invention.

### DESCRIPTION OF THE PREFERRED EMBODIMENTS

The embodiments of the present invention will be described hereinafter with reference to the drawings.

(1) First Embodiment

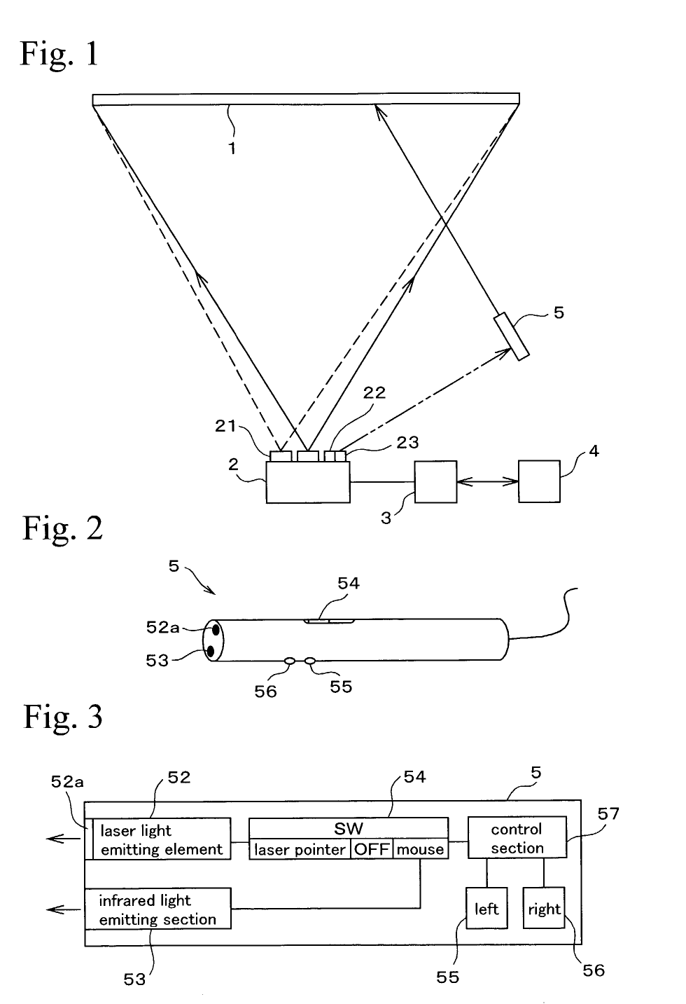

FIG. 1 schematically shows the entire system in the first embodiment according to the present invention. In FIG. 1, reference symbol 1 denotes a screen (screen device), 2 denotes a liquid crystal projector (projecting device) for projecting a liquid crystal image onto the screen 1, 3 denotes an image processing section (a processing section), 4 denotes a personal computer, and 5 denotes a laser pointer held by a presenter. In the personal computer 4, liquid crystal image data is generated. The image data, as well as various commands, are input from the personal computer 4 into the image processing section 3. The image data processed by the image processing section 3 is input into the liquid crystal projector 2, and an image based on the image data is projected from the liquid crystal projector 2 onto the screen 1 as a visible image.

FIG. 2 shows the appearance of the laser pointer 5. FIG. 3 is a block diagram showing the configuration of the laser pointer 5. This laser pointer 5 includes a laser beam emitting element 52, a laser beam projection section 52a and an infrared light emitting section (infrared light emitting device) 53. The light emitting direction of infrared light from the infrared light emitting section 53 is set to be approximately the same as the projection direction of a laser beam projected from the laser beam projection section 52a. The wavelength of the infrared light emitted from the infrared light emitting section 53 is, for example, about 850 to 950 nm, which wavelength greatly differs from that of infrared light of about 10 μm emitted by the human body.

As shown in FIG. 3, the laser pointer 5 is equipped with a switch (switching device) 54 switching over from a presently used mode between a laser pointer mode and a mouse mode with an OFF position located between the positions of these modes. The tip end of the laser pointer 5 is directed to the screen 1 and the switch 54 is changed over from OFF to the laser pointer mode (turned on), whereby a laser beam is projected from the projection section 52a of the laser beam emitting element 52 onto the screen 1. On the other hand, if the switch 54 is changed to the mouse mode, the laser pointer 5 can be used in place of a mouse, as will be described later, while stopping the laser beam emitting element 52. In addition, the laser pointer 5 is equipped with a left button 55 and a right button 56 which are used in the mouse mode. A mode change signal from the switch 54 and operation signals from the respective buttons 55 and 56 are supplied to a control section (laser beam control device) 57.

As shown in FIG. 1, the liquid crystal projector 2 is equipped with an infrared light sensing section (infrared light sensing device) 21 which photographs the projected image of infrared light emitted from the infrared light emitting section 53 of the laser pointer 5 projected onto the screen 1. This infrared light sensing section 21 consists of an image pickup device of a CCD or PSD and senses the center of the projected image of the infrared light. If the switch 54 of the laser pointer 5 is set at the mouse mode and the laser pointer 5 is moved toward the screen 1 in this state, then the infrared light sensing section 21 senses the movement of the projected image of the infrared light on the screen 1. Movement data on the movement direction and the movement distance of the center of the projected image of the infrared light on the screen 1 sensed by the infrared light sensing section 21 is supplied to the image processing section 3. The image processing section 3 generates a mouse image based on the movement data and supplies the generated mouse image to the liquid crystal projector 2. As a result, a mouse image in accordance with the movement of the laser pointer 5 is synthesized and projected onto the screen 1.

Furthermore, by performing the same operation as a conventional mouse operation while appropriately depressing the left and right buttons 55 and 56 of the laser pointer 5 in the mouse mode, it is possible to execute various commands (such as a range designation command, an image scrolling command, and a page turning command) on the visible image.

Furthermore, as shown in FIG. 1, the liquid crystal projector 2 is equipped with a human body sensor 22. This human body sensor 22 senses heat emitted from a human body in proximity to the liquid crystal projector 2. Specifically, the sensor 22 receives an infrared ray in a quantity corresponding to the temperature difference between the surface of the human body as a heat source and the background and determines whether or not the heat source is a human body. For reference, infrared rays with a wavelength of about 10 μm are emitted from the human body at the highest level and the human body sensor 22 senses the infrared rays at such a wavelength. The operating state (whether or not the sensor 22 senses a human body) of the human body sensor 22 is consecutively detected by a control section (laser beam control device) 23 provided on the liquid crystal projector 2. When the human body sensor 22 senses a human body and operates, the control section 23 transmits a driving stop signal to stop the driving of the laser beam emitting element 52 to the control section 57 of the laser pointer 5 as a wireless signal. That is, if the human body sensor 22 operates, the laser pointer 5 is controlled not to project a laser beam.

According to this embodiment, the presenter makes a presentation while directing the laser pointer 5 toward the screen 1 onto which a visible image is projected from the liquid crystal projector 2, changing over the mode of the switch 54 to the laser pointer mode to project laser beam, and indicating the visible image by the laser beam. If a person is present around the human body sensor 22 and the sensor operates, then a driving stop signal to stop the driving of the laser beam emitting element 54 is transmitted from the control section 23 to the control section 57 of the laser pointer 5 and no laser beam is projected. It is, therefore, possible to avoid the danger of projecting a laser beam onto an eye in the laser pointer mode.

If a mouse operation is then to be performed, the mode of the switch 54 is changed over to the mouse mode and the laser pointer 5 is directed toward the screen 1. If so, the infrared light sensing section 21 senses the center of the infrared light emitted from the infrared light emitting section 53 projected onto the screen 1, and the image processing section 3 generates a mouse image based on movement data in accordance with the movement of the laser pointer 5 (mouse operation). The mouse image is supplied to the liquid crystal projector 2 and is synthesized with a visible image, and the resultant synthesized image is projected onto the screen 1. That is, since the mouse image according to the movement of the laser pointer 5 is projected onto the screen 1, the presenter adjusts the movement of the mouse image to a desired location while viewing the mouse image. Furthermore, by performing the same operation as the conventional mouse operation while appropriately depressing the left or right buttons 55 and 56 of the laser pointer 5, it is possible to execute various commands (such as a range designation command, an image scrolling command, and a page turning command) on the visible image.

In the first embodiment, unlike in the conventional systems, it is possible to perform the mouse operation by moving the laser pointer 5 toward the screen 1 in the mouse mode without using the mouse. The presenter can swiftly change the mode to the laser pointer mode or to the mouse mode using the switch 54 of the laser pointer 5. Therefore, restrictions necessitating that the personal computer 4 be disposed near the presenter to perform the mouse operation and that the presenter not be away from the personal computer 4, and the like, do not exist. The freedom of the position and movement of the presenter is thereby improved. It is thus possible to provide a smooth presentation.

Moreover, if a mouse image is to be formed, the infrared light sensing section 21 detects the projected image of infrared light, the image processing section 3 converts only the movement direction or movement distance of the projected image and generates a mouse image instead of operating the absolute position of the projected image of the infrared light on the screen 1 as coordinates of the infrared light and projecting the mouse image onto the screen from the operation result. Therefore, the program of the image processing section 3 need not complicated, making it possible to minimize cost.

(2) Second Embodiment

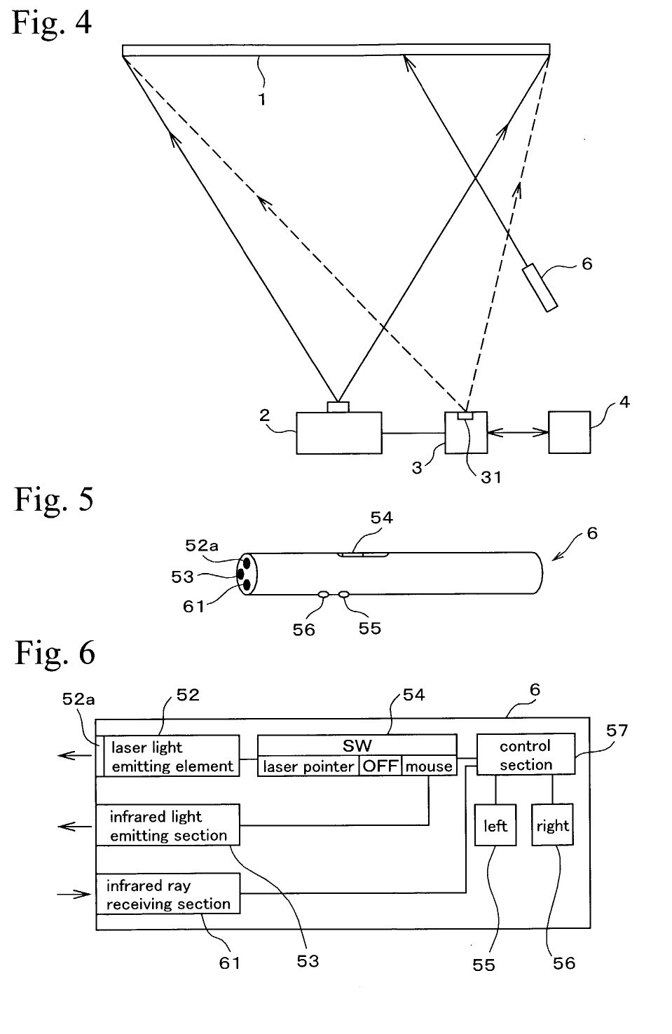

FIG. 4 schematically shows the entire system in the second embodiment according to the present invention. The system in the second embodiment includes a screen 1, a liquid crystal projector 2, an image processing section 3, and a personal computer 4, as in the case of the first embodiment. In this embodiment, the system is equipped with an image processing section 3 with an infrared light projection section 31 (infrared light projecting device) projecting infrared light over approximately the entire surface of the screen 1. It is desirable that infrared light be projected from the infrared light projection section 31 and that it be emitted from the infrared light emitting section 53 of the laser pointer 6 have wavelengths different from each other by a certain degree so as to avoid mutual interference and that this be modulated. For example, the wavelength of the infrared light projected from the infrared light projection section may be set at about 850 nm and that of the infrared light emitted from the infrared light emitting section of the laser pointer may be set at about 950 nm.

FIG. 5 shows the appearance of the laser pointer 6 in the second embodiment, and FIG. 6 is a block diagram showing the configuration of the laser pointer. This laser pointer 6 includes a laser beam emitting element 52 for a laser pointer mode, a laser beam projection section 52a, an infrared light emitting section 53 for a mouse mode, and left and right buttons 55 and 56, as in the case of the first embodiment. This laser pointer 6 also includes an infrared light receiving section 61. This infrared light receiving section 61 receives infrared light which is oriented in the same direction as the projection direction of the laser beam from the laser beam projection section 52a, projected from the infrared light projection section 31 and reflected by the screen 1. The infrared light projected from the infrared light projection section 31 is reflected by the screen 1, whereby the infrared light is attenuated. The wavelength of the infrared light received by the infrared light receiving section 61 is set to fall within the range of the attenuated wavelength.

The control section 57 of the laser pointer 6 drives the laser beam emitting element 52 only when the infrared light receiving section 61 receives infrared light while the switch 54 is in the laser pointer mode. If the infrared light receiving section 61 does not receive infrared light, the control section 57 stops driving the laser beam emitting element 52. That is, the control section 57 controls the laser beam projection section 52a to project a laser beam from the laser pointer 6 when the infrared light receiving section 61 receives infrared light and to not project a laser beam when the infrared light receiving section 61 does not receive infrared light.

In the second embodiment, the functions of the laser pointer mode and the mouse mode are the same as those in the first embodiment. In the laser pointer mode, the infrared light receiving section 61 receives infrared light reflected by the screen 1 while the laser pointer 6 is directed toward the screen 1. At this time, a laser beam is projected from the laser pointer 6 onto the screen 1. While the direction of the laser pointer 6 is away from the screen 1, the infrared light receiving section 61 does not receive the infrared light reflected by the screen 1 and no laser beam is projected onto the screen 1. That is, a laser beam is projected only when the laser pointer 6 is directed toward the screen 1.

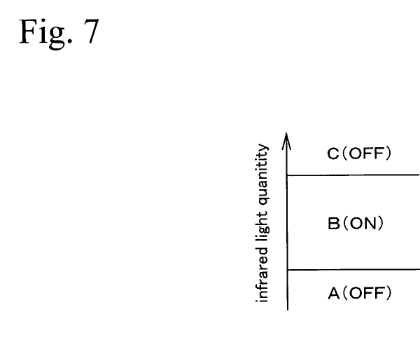

FIG. 7 shows a state in which the projection of a laser beam is turned on and off according to a change in the wavelength of the infrared light reflected from the screen 1. If the laser pointer 6 is directed toward the screen 1 and the infrared light receiving section 61 receives infrared light with wavelengths in a predetermined range (a range B), a laser beam is projected onto the screen 1. If the laser pointer 6 is directed toward the region of the infrared light projected from the infrared light projection section 31 (a range C), no laser beam is projected. If the laser pointer 6 is directed toward a region other than the region of the infrared light reflected from the screen 1 and projected from the infrared light projection section 31 (a range A), no laser beam is projected. It is, therefore, possible to prevent the erroneous projection of the laser beam and thereby safely give a presentation.

What is claimed is:

1. A presentation system using a laser pointer, comprising:
a screen device;
a projecting device for projecting a visible image onto the screen device; and
a laser pointer operated by a user, and projecting a laser beam onto the screen device,
the laser pointer comprising:
an infrared light emitting device for emitting an infrared light approximately in the same direction as a projection direction of the laser beam; and
a switching device for switching the mode between a laser pointer mode for projecting the laser beam and a mouse mode for emitting the infrared light from the infrared light emitting device,
the presentation system further comprising:
an infrared light sensing device for sensing a projected image of the infrared light emitted from the infrared light emitting device to the screen device; and
a processing section for generating movement data consisting of a movement direction and a movement distance of the projected image of the infrared light sensed by the infrared light sensing device, and for supplying the movement data to the projecting device;
wherein the projecting device projects a mouse image onto the screen device based on the movement data supplied from the processing section.

2. A presentation system using a laser pointer according to claim 1, wherein the system further comprises:
a human body sensor for sensing heat emitted from a human body present in the projection direction of the laser beam from the laser pointer; and
a laser beam control device for controlling the projection of the laser beam projected from the laser pointer when the human body sensor operates.

3. A presentation system using a laser pointer according to claim 1, wherein the system further comprises:
an infrared light projecting device for projecting the infrared light over approximately the entire surface of the screen device; and
the laser pointer further comprises:
an infrared light receiving section for receiving the infrared light oriented in the same direction as the projection direction of the laser beam, projected from the infrared light projecting device and reflected by the screen device; and
a laser beam control device for projecting the laser beam only when the infrared light receiving section receives the infrared light.
